(19) United States
(12) Patent Application Publication
(10) Pub. No.: US 2024/0072981 A1
(43) Pub. Date: Feb. 29, 2024

(54) DOWNLINK CONTROL INFORMATION HAVING A TRANSMISSION CONFIGURATION INDICATOR BITMAP

(71) Applicant: LENOVO (BEIJING) LIMITED, Beijing (CN)

(72) Inventors: Chenxi Zhu, Fairfax, VA (US); Bingchao Liu, Beijing (CN); Wei Ling, Beijing (CN); Yi Zhang, Beijing (CN); Lingling Xiao, Beijing (CN)

(21) Appl. No.: 18/260,538

(22) PCT Filed: Jan. 7, 2021
(86) PCT No.: PCT/CN2021/070667

§ 371 Date: Jul. 6, 2023

(51) Int. Cl. H04L 5/00; H04W 72/23

(52) U.S. Cl. CPC H04L 5/0094; H04W 72/23

(57) ABSTRACT

Apparatuses, methods, and systems are disclosed for downlink control information having a transmission configuration indicator bitmap. One method (400) includes transmitting (402) downlink control information with a transmission configuration indicator, spatial information, or a combination thereof and a transmission configuration indicator bitmap field. Each bit in the transmission configuration indicator bitmap field indicates whether the transmission configuration indicator, the spatial information, or the combination thereof applies to a channel or resource group.

### FIELD

The subject matter disclosed herein relates generally to wireless communications and more particularly relates to downlink control information having a transmission configuration indicator bitmap.

### BACKGROUND

The following abbreviations are herewith defined, at least some of which are referred to within the following description: Third Generation Partnership Project (“3GPP”), 5G Globally Unique Temporary UE Identifier (“5G-GUTI”), 5G QoS Indicator (“5QI”), Authentication Authorization and Accounting (“AAA”), Acknowledge Mode (“AM”), Access and Mobility Management Function (“AMF”), Aperiodic (“AP”), Authentication Server Function (“AUSF”), Backhaul (“BH”), Broadcast Multicast (“BM”), Buffer Occupancy (“BO”), Base Station (“BS”), Buffer Status Report (“BSR”), Bandwidth (“BW”), Bandwidth Part (“BWP”), Carrier Aggregation (“CA”), Code Block Group (“CBG”), CBG Flushing Out Information (“CBGFI”), CBG Transmission Information (“CBGTI”), Component Carrier (“CC”), Control Channel Element (“CCE”), Code Division Multiplexing (“CDM”), Control Element (“CE”), Coordinated Multipoint (“CoMP”), Categories of Requirements (“CoR”), Control Resource Set (“CORESET”), Cyclic Prefix (“CP”), Cyclic Prefix OFDM (“CP-OFDM”), Cyclic Redundancy Check (“CRC”), CSI-RS Resource Indicator (“CRI”), Cell RNTI (“C-RNTI”), Channel State Information (“CSI”), CSI IM (“CSI-IM”), CSI RS (“CSI-RS”), Channel Quality Indicator (“CQI”), Central Unit (“CU”), Codeword (“CW”), Downlink Assignment Index (“DAI”), Downlink Control Information (“DCI”), Downlink Feedback Information (“DFI”), Downlink (“DL”), Discrete Fourier Transform Spread OFDM (“DFT-s-fOFDM”), Demodulation Reference Signal (“DMRS” or “DM-RS”), Data Radio Bearer (“DRB”), Dedicated Short-Range Communications (“DSRC”), Distributed Unit (“DU”), Enhanced Mobile Broadband (“eMBB”), Evolved Node B (“eNB”), Enhanced Subscriber Identification Module (“eSIM”), Enhanced (“E”), Edge Application Server (“EAS”), Edge Configuration Server (“ECS”), Edge Enabler Client (“EEC”), Edge Enabler Server (“EES”), Frequency Division Duplex (“FDD”), Frequency Division Multiplexing (“FDM”), Frequency Division Multiple Access (“FDMA”), Fully-Qualified Domain Name (“FQDN”), Frequency Range (“FR”), 450 MHz-6000 MHz (“FR1”), 24250 MHz-52600 MHz (“FR2”), Globally Unique Temporary UE Identifier (“GUTI”), Hybrid Automatic Repeat Request (“HARQ”), High-Definition Multimedia Interface (“HDMI”), High-Speed Train (“HST”), Integrated Access Backhaul (“IAB”), Identity or Identifier or Identification (“ID”), Information Element (“IE”), Interference Measurement (“IM”), International Mobile Subscriber Identity (“IMSI”), Internet-of-Things (“IoT”), Internet Protocol (“IP”), Joint Transmission (“JT”), Key Derivation Function (“KDF”), Level 1 (“L1”), L1 RSRP (“L1-RSRP”), L1 SINR (“L1-SINR”), Level 2 (“L2”), Logical Channel (“LCH”), Logical Channel Group (“LCG”), Logical Channel ID (“LCID”), Logical Channel Prioritization (“LCP”), Layer Indicator (“LI”), Least-Significant Bit (“LSB”), Long Term Evolution (“LTE”), Levels of Automation (“LoA”), Medium Access Control (“MAC”), Message Authentication Code for Integrity (“MAC-I”), Modulation Coding Scheme (“MCS”), Multi DCI (“M-DCI”), Mobile Edge Computing (“MEC”), Master Information Block (“MIB”), Multiple Input Multiple Output (“MIMO”), Maximum Permissible Exposure (“MPE”), Most-Significant Bit (“MSB”), Mobile Station International Subscriber Directory Number (“MSISDN”), Mobile-Termination (“MT”), Machine Type Communication (“MTC”), Multi PDSCH (“Multi-PDSCH”), Multi TRP (“M-TRP”), Multi-User (“MU”), Multi-User MIMO (“MU-MIMO”), Minimum Mean Square Error (“MMSE”), Negative-Acknowledgment (“NACK”) or (“NAK”), Network Access Identifier (“NAI”), Non Access Stratum (“NAS”), Non-Coherent Joint Transmission (“NCJT”), Network Exposure Function (“NEF”), Next Generation (“NG”), Next Generation Node B (“gNB”), Generic Public Subscription Identifier (“GPSI”), New Radio (“NR”), Non-Zero Power (“NZP”), NZP CSI-RS (“NZP-CSI-RS”), Orthogonal Frequency Division Multiplexing (“OFDM”), Peak-to-Average Power Ratio (“PAPR”), Physical Broadcast Channel (“PBCH”), Physical Downlink Control Channel (“PDCCH”), Physical Downlink Shared Channel (“PDSCH”), PDSCH Configuration (“PDSCH-Config”), Policy Control Function (“PCF”), Packet Data Convergence Protocol (“PDCP”), Packet Data Network (“PDN”), Protocol Data Unit (“PDU”), Permanent Equipment Identifier (“PEI”), Public Land Mobile Network (“PLMN”), Precoding Matrix Indicator (“PMI”), ProSe Per Packet Priority (“PPPP”), ProSe Per Packet Reliability (“PPPR”), Physical Resource Block (“PRB”), Packet Switched (“PS”), Physical Sidelink Control Channel (“PSCCH”), Physical Sidelink Shared Channel (“PSSCH”), Phase Tracking RS (“PTRS” or “PT-RS”), Physical Uplink Control Channel (“PUCCH”), Physical Uplink Shared Channel (“PUSCH”), Quasi Co-Located (“QCL”), Quality of Service (“QoS”), Random Access Channel (“RACH”), Radio Access Network (“RAN”), Radio Access Technology (“RAT”), Resource Element (“RE”), Radio Frequency (“RF”), Rank Indicator (“RI”), Radio Link Control (“RLC”), Radio Link Failure (“RLF”), Radio Network Temporary Identifier (“RNTI”), Resource Pool (“RP”), Radio Resource Control (“RRC”), Remote Radio Head (“RRH”), Reference Signal (“RS”), Reference Signal Received Power (“RSRP”), Reference Signal Received Quality (“RSRQ”), Redundancy Version (“RV”), Receive (“RX”), Security Association (“SA”), Service Based Architecture (“SBA”), Single Carrier Frequency Domain Spread Spectrum (“SC-FDSS”), Secondary Cell (“SCell”), Spatial Channel Model (“SCM”), Sub Carrier Spacing (“SCS”), Single DCI (“S-DCI”), Spatial Division Multiplexing (“SDM”), Service Data Unit (“SDU”), Single Frequency Network (“SFN”), Subscriber Identity Module (“SIM”), Signal-to-Interference Ratio (“SINR”), Sidelink (“SL”), Session Management Function (“SMF”), Sequence Number (“SN”), Semi Persistent (“SP”), Scheduling Request (“SR”), SRS Resource Indicator (“SRI”), Sounding Reference Signal (“SRS”), Synchronization Signal (“SS”), SS/PBCH Block (“SSB”), Subscription Concealed Identifier (“SUCI”), Subscription Permanent Identifier (“SUPI”), Transport Block (“TB”), Transmission Configuration Indication (“TCI”), Time Division Duplex (“TDD”), Time Division Multiplexing (“TDM”), Temporary Mobile Subscriber Identity (“TMSI”), Transmit Power Control (“TPC”), Transmitted Precoding Matrix Indicator (“TPMI”), Transmission Reception Point (“TRP”), Transmission Reference Signal (“TRS”), Technical Standard (“TS”), Transmit (“TX”), Unified Data Management (“UDM”), User Data Repository (“UDR”), User Entity/Equipment (Mobile Terminal) (“UE”), Universal Integrated Circuit Card (“UICC”), Uplink (“UL”), Uplink Power Control (“UL-PC”), Unacknowledged Mode (“UM”), Universal Mobile Telecommunications System (“UMTS”), LTE Radio Interface (“Uu interface”), User Plane (“UP”), User Plane Function (“UPF”), Ultra Reliable Low Latency Communication (“URLLC”), Universal Subscriber Identity Module (“USIM”), Universal Terrestrial Radio Access Network (“UTRAN”), Vehicle to Everything (“V2X”), Voice Over IP (“VoIP”), Visited Public Land Mobile Network (“VPLMN”), Virtual Resource Block (“VRB”), Vehicle RNTI (“V-RNTI”), Worldwide Interoperability for Microwave Access (“WiMAX”), Zero Forcing (“ZF”), Zero Power (“ZP”), and ZP CSI-RS (“ZP-CSI-RS”). As used herein, “HARQ-ACK” may represent collectively the Positive Acknowledge (“ACK”) and the Negative Acknowledge (“NAK”). ACK means that a TB is correctly received while NAK means a TB is erroneously received.

In certain wireless communications networks, TCIs may be used.

### BRIEF SUMMARY

Methods for downlink control information having a transmission configuration indicator bitmap are disclosed. Apparatuses and systems also perform the functions of the methods. In one embodiment, the method includes transmitting downlink control information with a transmission configuration indicator, spatial information, or a combination thereof and a transmission configuration indicator bitmap field, wherein each bit in the transmission configuration indicator bitmap field indicates whether the transmission configuration indicator, the spatial information, or the combination thereof applies to a channel or resource group.

An apparatus for downlink control information having a transmission configuration indicator bitmap, in one embodiment, includes a transmitter that transmits downlink control information with a transmission configuration indicator, spatial information, or a combination thereof and a transmission configuration indicator bitmap field, wherein each bit in the transmission configuration indicator bitmap field indicates whether the transmission configuration indicator, the spatial information, or the combination thereof applies to a channel or resource group.

In various embodiments, a method for downlink control information having a transmission configuration indicator bitmap includes receiving downlink control information with a transmission configuration indicator, spatial information, or a combination thereof and a transmission configuration indicator bitmap field, wherein each bit in the transmission configuration indicator bitmap field indicates whether the transmission configuration indicator, the spatial information, or the combination thereof applies to a channel or resource group.

In some embodiments, an apparatus for downlink control information having a transmission configuration indicator bitmap includes a receiver that receives downlink control information with a transmission configuration indicator, spatial information, or a combination thereof and a transmission configuration indicator bitmap field, wherein each bit in the transmission configuration indicator bitmap field indicates whether the transmission configuration indicator, the spatial information, or the combination thereof applies to a channel or resource group.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for downlink control information having a transmission configuration indicator bitmap;

FIG. 2 is a schematic block diagram illustrating one embodiment of an apparatus that may be used for downlink control information having a transmission configuration indicator bitmap;

FIG. 3 is a schematic block diagram illustrating another embodiment of an apparatus that may be used for downlink control information having a transmission configuration indicator bitmap;

FIG. 4 is a schematic flow chart diagram illustrating one embodiment of a method for downlink control information having a transmission configuration indicator bitmap; and

FIG. 5 is a schematic flow chart diagram illustrating another embodiment of a method for downlink control information having a transmission configuration indicator bitmap.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

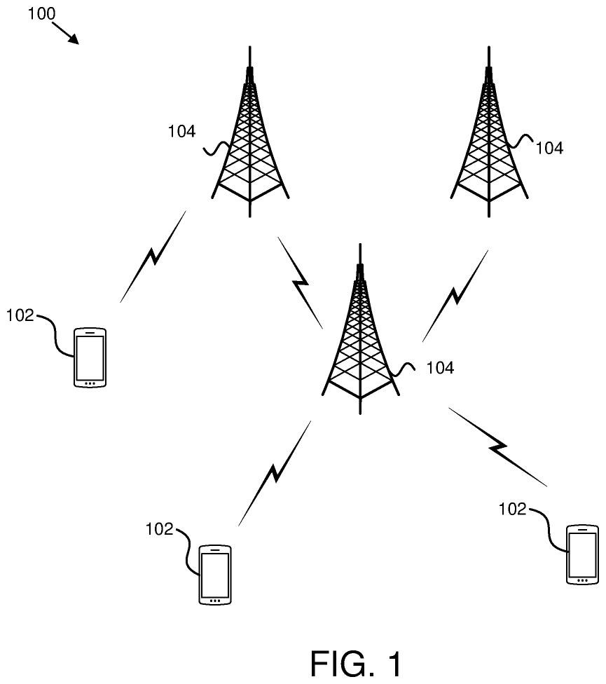

FIG. 1 depicts an embodiment of a wireless communication system 100 for downlink control information having a transmission configuration indicator bitmap. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), IoT devices, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals and/or the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a RAN, a relay node, a device, a network device, an IAB node, a donor IAB node, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with the 5G or NG (Next Generation) standard of the 3GPP protocol, wherein the network unit 104 transmits using NG RAN technology. More generally, however, the wireless communication system 100 may implement some other open or proprietary communication protocol, for example, WiMAX, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a network unit 104 may transmit downlink control information with a transmission configuration indicator, spatial information, or a combination thereof and a transmission configuration indicator bitmap field, wherein each bit in the transmission configuration indicator bitmap field indicates whether the transmission configuration indicator, the spatial information, or the combination thereof applies to a channel or resource group. Accordingly, a network unit 104 may be used for downlink control information having a transmission configuration indicator bitmap.

In some embodiments, a remote unit 102 may receive downlink control information with a transmission configuration indicator, spatial information, or a combination thereof and a transmission configuration indicator bitmap field, wherein each bit in the transmission configuration indicator bitmap field indicates whether the transmission configuration indicator, the spatial information, or the combination thereof applies to a channel or resource group. Accordingly, a remote unit 102 may be used for downlink control information having a transmission configuration indicator bitmap.

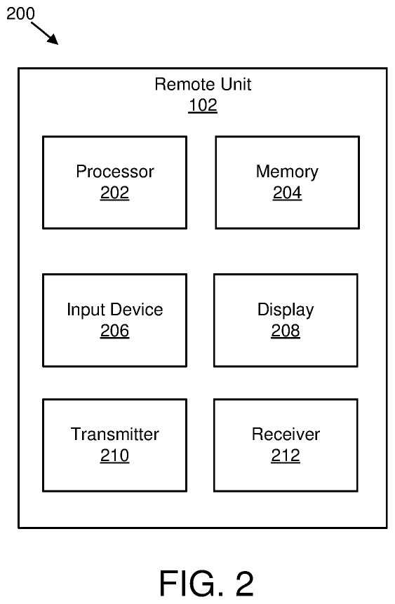

FIG. 2 depicts one embodiment of an apparatus 200 that may be used for downlink control information having a transmission configuration indicator bitmap. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, an LCD display, an LED display, an OLED display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

In various embodiments, the receiver 212: receives downlink control information with a transmission configuration indicator, spatial information, or a combination thereof and a transmission configuration indicator bitmap field, wherein each bit in the transmission configuration indicator bitmap field indicates whether the transmission configuration indicator, the spatial information, or the combination thereof applies to a channel or resource group.

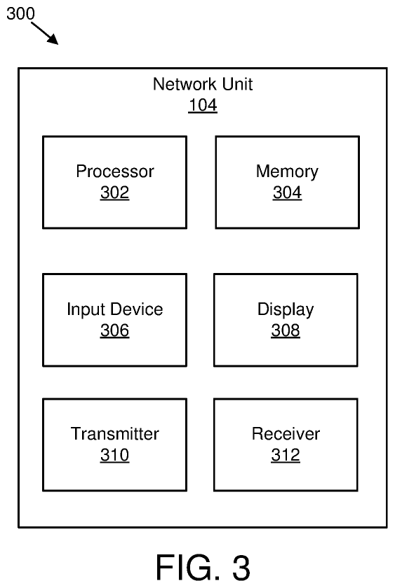

FIG. 3 depicts another embodiment of an apparatus 300 that may be used for downlink control information having a transmission configuration indicator bitmap. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In some embodiments, the transmitter 310: transmits downlink control information with a transmission configuration indicator, spatial information, or a combination thereof and a transmission configuration indicator bitmap field, wherein each bit in the transmission configuration indicator bitmap field indicates whether the transmission configuration indicator, the spatial information, or the combination thereof applies to a channel or resource group. It should be noted that, as used herein, spatial information, UL TCI, and/or an UL TX beam indicator may mean substantially the same thing.

Although only one transmitter 310 and one receiver 312 are illustrated, the network unit 104 may have any suitable number of transmitters 310 and receivers 312. The transmitter 310 and the receiver 312 may be any suitable type of transmitters and receivers. In one embodiment, the transmitter 310 and the receiver 312 may be part of a transceiver.

In certain embodiments, if a DCI-based beam indication is applied, a DCI format (e.g., DCI format 1_1, DCI format 1_2) may be sent to a UE to signal a new beam. The new beam may be used for PDSCH, PDCCH, PUSCH, and/or PUCCH. Various embodiments for signaling which channels the new beam applies to are described herein.

In some embodiments, such as for various DCI formats (e.g., DCI format 1_1, DCI format 1_2, etc.), a TCI field can be used to indicate a common TCI. The common TCI may be applied to PDSCH, PUSCH, some or all CORESETs, and/or some or all PUCCH resources. In various embodiments, if a PDSCH is scheduled by a DCI containing a TCI field, an indicated TCI state may be applied to the PDSCH if there is enough time for a UE to apply the indicated TCI state for reception. In certain embodiments, to signal to a UE which channels a new TCI is for, a bitmap (e.g., TCI update indicator field) may be included in a DCI format along with a TCI field. In such embodiments, each bit of the bitmap may represent a channel type or a set of resources. For example, the bitmap (e.g., TCI update indicator field) may have the following contents:
1) a bit to represent a PDSCH channel. This bit is set to 1 if an indicated TCI state applies to PDSCH transmissions, and 0 otherwise. If the bit is set to 1, the TCI applies to all PDSCH transmissions (e.g., including DCI scheduled PDSCH and SPS-PDSCH) in a carrier indicated by a carrier indicator field of the DCI in a bandwidth part indicated by a bandwidth part indicator of the DCI. In various embodiments, the TCI applies to all bandwidth parts of the carrier. In certain embodiments, if a carrier is configured as part of a simultaneous (or concurrent) TCI update list (e.g., simultaneousTCI-UpdateList1-r16, simultaneousTCI-UpdateList2-r16, or another list of carriers defined by RRC signaling), a TCI applies to PDSCH transmissions in all serving cells in the simultaneous (or concurrent) TCI update list;
2) a bit to represent a PUSCH channel. This bit is set to 1 if the indicated TCI state as spatial information of an UL TX beam applies to PUSCH transmissions, and 0 otherwise. If the bit is set to 1, the TCI applies to all PUSCH transmission as the UL TX beam in the carrier indicated by the carrier indicator field of the DCI in the bandwidth part indicated by the bandwidth part indicator of the DCI. In some embodiments, the TCI applies to all bandwidth parts of the carrier. In various embodiments, if a carrier is configured as part of a simultaneous (or concurrent) spatial relation update list (e.g., simultaneousSpatial-UpdateList1-r16, simultaneousSpatial-UpdateList2-r16, or another list of carriers defined by RRC signaling), a spatial relation may apply to all serving cells in the simultaneous (or concurrent) spatial relation update list;
3) K bits to represent a PDCCH channel, in which each bit of the K bits represents a CORESET group in the carrier indicated by the carrier indicator field of the DCI. This bit is set to 1 if an indicated TCI state applies to PDCCH transmitted in the CORESETs in a corresponding CORESET group, and 0 otherwise. The CORESETs of the carrier may be grouped into K groups, and all the CORESETs in a group share the same TCI state. The number of CORESET groups K and the CORESETs in the groups may be configured by RRC signaling or by a MAC-CE. In one example, K=2, a first CORESET group includes CORESET0, and a second group includes all other CORESETs of the carrier. In another example, K=2, a first group includes CORESET0 and all CORESETs of the carrier with CORESETPoolIndex=0, and a second group includes all CORESETs of the carrier with CORESETPoolIndex=1. In certain embodiments, a bit corresponding to a CORESET group is set to 1 if the TCI applies to all the CORESETs in the group, and 0 otherwise. In various embodiments, if a carrier is configured as part of a simultaneous (or concurrent) TCI update list (e.g., simultaneousTCI-UpdateList1-r16, simultaneousTCI-UpdateList2-r16, or another list of carriers defined by RRC signaling), a TCI applies to all serving cells in the simultaneous (or concurrent) TCI update list. In some embodiments, different CORESET groups may be configured in different carriers. For example, CORESET group1 of cc1 (e.g., component carrier 1) may include CORESETs with CORESET ID {1,2}, CORESET group1 of cc2 (e.g., component carrier 2) may include CORESETs with CORESET ID {1,3}. In such an example, if CORESET group1 is activated with TCI state 1 in cc1 by DCI, and both cc1 and cc2 are in simultaneousTCI-UpdateList1-r16, then all the CORESETs in CORESET group 1 in cc1 and CORESET group 2 in cc2 get the TCI state 1; and
4) L bits to represent a PUCCH channel, in which each bit of the L bits represents a PUCCH resource group (e.g., PUCCH-ResourceGroup-r16, or another group defined by RRC signaling) in the carrier indicated by the carrier indicator field of the DCI in the bandwidth part indicated by the bandwidth part indicator of the DCI. This bit is set to 1 if an indicated TCI state applies to PUCCH resources transmitted in a corresponding PUCCH resource group, and 0 otherwise. In certain embodiments, a TCI state may apply to all bandwidth parts of the carrier. In various embodiments, the bit is set to 1 if the TCI state as a spatial relation of an UL TX beam is to be applied to all PUCCH resources in a corresponding PUCCH resource group, and 0 otherwise. In some embodiments, the TCI state applies to all bandwidth parts of the carrier. In certain embodiments, if the carrier is configured as part of a simultaneous (or concurrent) spatial relation update list (e.g., simultaneousSpatial-UpdateList1-r16, simultaneousSpatial-UpdateList2-r16, or another list of carriers defined by RRC signaling), a spatial relation may apply to all serving cells in the simultaneous (or concurrent) spatial relation update list. In various embodiments, different PUCCH resource groups may be configured in different carriers. For example, a PUCCH resource group1 of cc1 (e.g., component carrier 1) may include PUCCH resources {1,2}, a PUCCH resource group1 of cc2 (e.g., component carrier 2) may include PUCCH resources {1,3}. In such an example, if PUCCH resource group 1 is activated with TCI state 1 in cc1 by DCI, and both cc1 and cc2 are in simultaneousSpatial-UpdateList1-r16, then all the PUCCH resources in PUCCH resource group 1 in cc1 and PUCCH resource group 2 in cc2 get the TCI state 1. As may be appreciated, a number of bits L (e.g., the number of PUCCH resource groups indicated in the DCI) may not be the same as a total number of PUCCH resource groups (e.g., PUCCH-ResourceGroup-r16). In some embodiments, a gNB may configure 4 PUCCH-ResourceGroup-r16 for a UE, but if L=1 the gNB may only signal the spatial relation information for one of the 4 groups. In such embodiments, a PUCCH resource group signaled in DCI may be configured by RRC signaling. Moreover, the spatial relations for the other 3 PUCCH groups may be activated and/or deactivated using a MAC-CE. It should be noted that a UE may not be expected to receive TCI information and/or a spatial relation update in DCI and in MAC-CE.

In various embodiments, such as for PDSCH and PDCCH, a TCI state may indicate an RX filter a UE is to use to receive the channel.

In certain embodiments, such as for PUSCH and PUCCH, a TCI state may be applied as spatial relation information, and a UE may use a corresponding TX filter for transmission. In such embodiments, if a DL TCI state is indicated by a TCI field, a spatial relation is determined by a QCL-TypeD RS contained in the DL TCI state. Moreover, in such embodiments, if an UL TCI state is indicated, a spatial relation is directly indicated.

In the following example, K=2 and L=2, and a total of 6 bits are used to represent an applicability of a TCI state. The bits are arranged as follows (from MSB to LSB): |PDSCH bit |PUSCH bit |CORESET group 1 bit |CORESET group 2 bit |PUCCH resource group 1 bit |PUCCH resource group 2 bit|.

Using this example, the following are bitmap examples for a carrier and bandwidth part indicated: 1) 100000: the TCI state applies to PDSCH; 2) 101000: the TCI state applies to PDSCH and PDCCH of all the CORESETs of CORESET group 1; 3) 010010: the TCI state applies to PUSCH and PUCCH resource group 1; 4) 010011: the TCI state applies to PUSCH, and PUCCH resources of PUCCH resource group 1 and PUCCH resource group 2; and 5) 111111: the TCI state applies to PDSCH, PUSCH, all PDCCH, and all PUSCH.

In this example, if a corresponding bit of a PDSCH, PUSCH, CORESET group, and/or PUCCH resource group is 0, the TCI state of the channel is not affected by the current DCI, so a previously signaled TCI state is still applied to the channel. Moreover, if the carrier is part of a simultaneousTCI-UpdateList1-r16 or a simultaneousTCI-UpdateList2-r16, an indicated TCI state applies to corresponding channels for all the carriers in the list.

In certain embodiments, an “TCI_all_bandwidth_parts” switch may be defined by RRC signaling and may be signaled to a UE to indicate whether a TCI state applies to all the bandwidth parts of a carrier or carriers. In such embodiments, if the “TCI_all_bandwidth_parts” switch is set to “Enabled”, the TCI state applies all the bandwidth parts; otherwise, the TCI state only applies to a bandwidth part signaled by a bandwidth part indicator field of DCI. The “TCI_all_bandwidth_parts” switch may be defined for a carrier or for a channel type. If the “TCI_all_bandwidth_parts” switch is defined for a carrier, the TCI state of the signaled channels and/or resource groups of all bandwidth parts in the carrier are updated if it is “Enabled”. If the carrier is part of a carrier group (e.g., simultaneous TCI update list), the TCI state is applied to all the carriers of the carrier group. If the “TCI_all_bandwidth_parts” switch is defined per channel type, the TCI state of a corresponding channel or resource group for all bandwidth parts are updated with the TCI state if it is “Enabled”. In some embodiments, the TCI state update of a certain channel and/or resource group is always applied to all bandwidth parts of all channels of an indicated carrier. In such embodiments, this may be defined in a specification and no RRC parameter “TCI_all_bandwidth_parts” may be used. In other words, “TCI_all_bandwidth_parts” is always ‘Enabled”.

In various embodiments, if an UL TCI field is added to a DCI format (e.g., DCI format 0_1, DCI format 0_2), a TCI update indicator field may also be added to update TCI or spatial relation similarly for another DCI format (e.g., DCI format 1_1, DCI format 1_2). In certain embodiments, if a DL TCI state and an UL TCI (e.g., spatial relation information) are the same due to beam correspondence, all DCI formats (e.g., DCI format 0_1, DCI format 0_2, DCI format 1_1, DCI format 1_2) may be used to update a common beam for all channels, and they may have the same TCI update indicator field including a bitmap for PDSCH, PUSCH, CORESET groups, and/or PUCCH resource groups. In some embodiments, if a DL TCI state pool and an UL TCI and/or spatial relation information pool are separate, a DCI format (e.g., DCI format 1_1, DCI format 1_2) may be used to update the common beam for PDSCH and PDCCH using a DL TCI state and a TCI update indicator field may only include bits for PDSCH and CORESET groups, and another DCI format (e.g., DCI format 0_1, DCI format 0_2) may be used to update a common beam for PUSCH and PUCCH and the TCI update indicator field may only include bits for PUSCH and PUCCH resource groups.

In certain embodiments, besides using a specific DCI format (e.g., DCI format 1_1, DCI format 1_2, DCI format 0_1, and/or DCI format 0_2), a signaling method may be applied to other DCI formats, such as a new group common DCI format (e.g., DCI format 2_x) sent from a gNB to one or more UEs to update a common beam. In some embodiments, if DCI is for multiple UEs, the DCI may be scrambled with a specific new RNTI (e.g., TCI-update-RNTI) and there may be a block for each targeted UE. An index indicating which block corresponds to which UE may be defined by RRC signaling. Each block may contain the following fields for a UE: 1) a carrier indicator: 0 or 3 bits; 2) a bandwidth part indicator: 0, 1, or 2 bits as determined by a number of DL BWPs (e.g., nBWP,RRC) configured by higher layers, excluding an initial DL bandwidth part, or 0 bits if the TCT or spatial relation information is applied to all bandwidth parts, either defined in a specification or configured by TCI_all_bandwidth_parts=“Enabled”; 3) a TCI state or spatial relation information ID; and/or 4) a TCI update indicator field. In certain embodiments, a start block index and/or a block length (e.g., number of bits for the information) may be configured by RRC signaling for each UE.

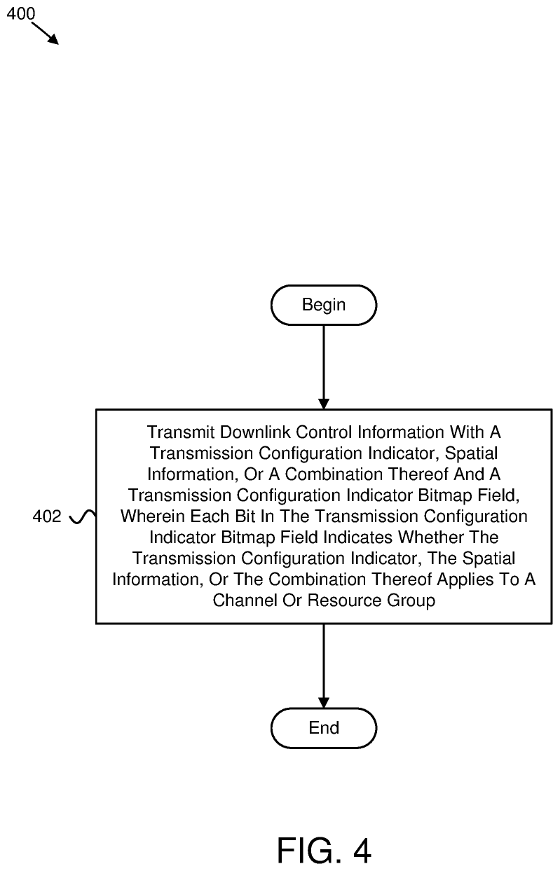

FIG. 4 a schematic flow chart diagram illustrating one embodiment of a method 400 for downlink control information having a transmission configuration indicator bitmap. In some embodiments, the method 400 is performed by an apparatus, such as the network unit 104. In certain embodiments, the method 400 may be performed by a processor executing program code, for example, a microcontroller, a microprocessor, a CPU, a GPU, an auxiliary processing unit, a FPGA, or the like.

The method 400 may include transmitting 402 downlink control information with a transmission configuration indicator, spatial information, or a combination thereof and a transmission configuration indicator bitmap field, wherein each bit in the transmission configuration indicator bitmap field indicates whether the transmission configuration indicator, the spatial information, or the combination thereof applies to a channel or resource group. The transmission configuration indicator, spatial information, or the combination thereof may be used for transmission of data and/or information on UL and/or DL channels that occur after transmitting the downlink control information with the transmission configuration indicator, spatial information, or the combination thereof, as described herein.

In certain embodiments, the channel comprises a physical downlink shared channel, a physical uplink shared channel, or a combination thereof, and the resource group comprises a control resource set group, a physical uplink control channel resource group, or a combination thereof. In some embodiments, the control resource set group is defined by radio resource control signaling to be a set of control resource sets that share the same transmission configuration indicator state. In various embodiments, the transmission configuration indicator, the spatial information, or the combination thereof applies to channels in a carrier indicated by a carrier indicator field of the downlink control information and to a bandwidth part indicated by a bandwidth part indicator field of the downlink control information.

In one embodiment, in response to the carrier being part of a carrier list for concurrently updating the transmission configuration indicator, the spatial information, or the combination thereof, the transmission configuration indicator, the spatial information, or the combination thereof is applied to corresponding channels, resource groups, or a combination thereof in all carriers of the carrier list. In certain embodiments, the carrier list for concurrently updating the transmission configuration indicator is simultaneousTCT-UpdateList1-r16 or simultaneousTCI-UpdateList2-r16, and the corresponding channels comprise a physical downlink shared channel, a physical downlink control channel, or a combination thereof. In some embodiments, the carrier list for concurrently updating the spatial information is simultaneousSpatial-UpdateList1-r16 or simultaneousSpatial-UpdateList2-r16, and the corresponding channels comprise a physical downlink shared channel, a physical downlink control channel, or a combination thereof.

In various embodiments, the transmission configuration indicator, the spatial information, or the combination thereof is applied to all bandwidth parts of the carriers. In one embodiment, the transmission configuration indicator, the spatial information, or the combination thereof is applied to all bandwidth parts of the carriers in response to a parameter TCI_all_bandwidth_parts being configured as enabled. In certain embodiments, the transmission configuration indicator bitmap field is configured by radio resource control signaling.

In some embodiments, the downlink control information is a downlink control information format 0_1, 0_2, 1_1, or 1_2. In various embodiments, the downlink control information is common downlink control information for a plurality of user equipments, and the downlink control information is scrambled by a TCI-update-RNTI. In one embodiment, the downlink control information comprises a plurality of blocks, each block of the plurality of blocks corresponds to a user equipment of the plurality of user equipments, each block of the plurality of blocks has a corresponding index, and radio resource control signaling configures which block index corresponds to which user equipment.

In certain embodiments, each block of the plurality of blocks comprises a carrier indicator, a bandwidth part indicator, a transmission configuration indicator state, a spatial information indicator, a transmission configuration indicator update indicator, or some combination thereof.

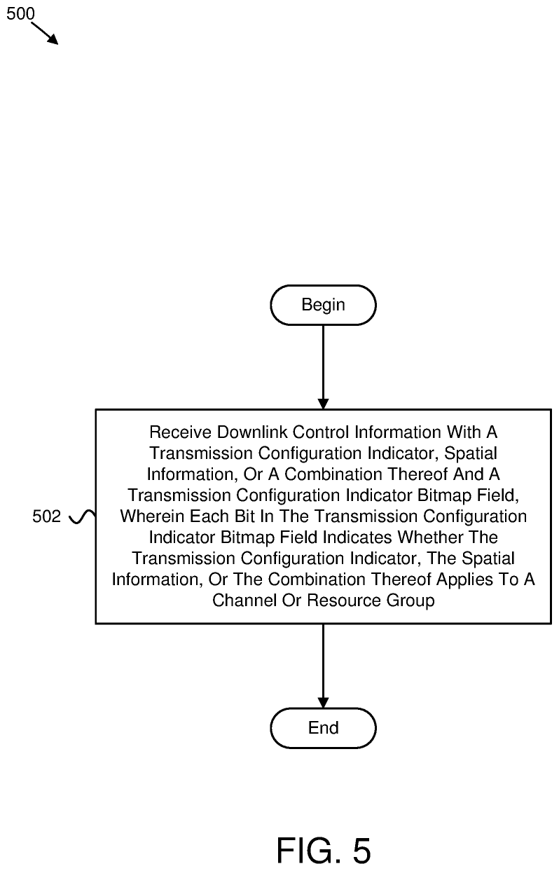

FIG. 5 is a schematic flow chart diagram illustrating another embodiment of a method 500 for downlink control information having a transmission configuration indicator bitmap. In some embodiments, the method 500 is performed by an apparatus, such as the remote unit 102. In certain embodiments, the method 500 may be performed by a processor executing program code, for example, a microcontroller, a microprocessor, a CPU, a GPU, an auxiliary processing unit, a FPGA, or the like.

The method 500 may include receiving 502 downlink control information with a transmission configuration indicator, spatial information, or a combination thereof and a transmission configuration indicator bitmap field, wherein each bit in the transmission configuration indicator bitmap field indicates whether the transmission configuration indicator, the spatial information, or the combination thereof applies to a channel or resource group. The transmission configuration indicator, spatial information, or the combination thereof may be used for transmission of data and/or information on UL and/or DL channels that occur after receiving the downlink control information with the transmission configuration indicator, spatial information, or the combination thereof, as described herein.

In certain embodiments, the channel comprises a physical downlink shared channel, a physical uplink shared channel, or a combination thereof, and the resource group comprises a control resource set group, a physical uplink control channel resource group, or a combination thereof. In some embodiments, the control resource set group is defined by radio resource control signaling to be a set of control resource sets that share the same transmission configuration indicator state. In various embodiments, the transmission configuration indicator, the spatial information, or the combination thereof applies to channels in a carrier indicated by a carrier indicator field of the downlink control information and to a bandwidth part indicated by a bandwidth part indicator field of the downlink control information.

In one embodiment, in response to the carrier being part of a carrier list for concurrently updating the transmission configuration indicator, the spatial information, or the combination thereof, the transmission configuration indicator, the spatial information, or the combination thereof is applied to corresponding channels, resource groups, or a combination thereof in all carriers of the carrier list. In certain embodiments, the carrier list for concurrently updating the transmission configuration indicator is simultaneousTCI-UpdateList1-r16 or simultaneousTCI-UpdateList2-r16, and the corresponding channels comprise a physical downlink shared channel, a physical downlink control channel, or a combination thereof. In some embodiments, the carrier list for concurrently updating the spatial information is simultaneousSpatial-UpdateList1-r16 or simultaneousSpatial-UpdateList2-r16, and the corresponding channels comprise a physical downlink shared channel, a physical downlink control channel, or a combination thereof.

In various embodiments, the transmission configuration indicator, the spatial information, or the combination thereof is applied to all bandwidth parts of the carriers. In one embodiment, the transmission configuration indicator, the spatial information, or the combination thereof is applied to all bandwidth parts of the carriers in response to a parameter TCI_all_bandwidth_parts being configured as enabled. In certain embodiments, the transmission configuration indicator bitmap field is configured by radio resource control signaling.

In some embodiments, the downlink control information is a downlink control information format 0_1, 0_2, 1_1, or 1_2. In various embodiments, the downlink control information is common downlink control information for a plurality of user equipments, and the downlink control information is scrambled by a TCI-update-RNTI.

In one embodiment, the downlink control information comprises a plurality of blocks, each block of the plurality of blocks corresponds to a user equipment of the plurality of user equipments, each block of the plurality of blocks has a corresponding index, and radio resource control signaling configures which block index corresponds to which user equipment. In certain embodiments, each block of the plurality of blocks comprises a carrier indicator, a bandwidth part indicator, a transmission configuration indicator state, a spatial information indicator, a transmission configuration indicator update indicator, or some combination thereof.

In one embodiment, a method comprises: transmitting downlink control information with a transmission configuration indicator, spatial information, or a combination thereof and a transmission configuration indicator bitmap field, wherein each bit in the transmission configuration indicator bitmap field indicates whether the transmission configuration indicator, the spatial information, or the combination thereof applies to a channel or resource group.

In certain embodiments, the channel comprises a physical downlink shared channel, a physical uplink shared channel, or a combination thereof, and the resource group comprises a control resource set group, a physical uplink control channel resource group, or a combination thereof.

In some embodiments, the control resource set group is defined by radio resource control signaling to be a set of control resource sets that share the same transmission configuration indicator state.

In various embodiments, the transmission configuration indicator, the spatial information, or the combination thereof applies to channels in a carrier indicated by a carrier indicator field of the downlink control information and to a bandwidth part indicated by a bandwidth part indicator field of the downlink control information.

In one embodiment, in response to the carrier being part of a carrier list for concurrently updating the transmission configuration indicator, the spatial information, or the combination thereof, the transmission configuration indicator, the spatial information, or the combination thereof is applied to corresponding channels, resource groups, or a combination thereof in all carriers of the carrier list.

In certain embodiments, the carrier list for concurrently updating the transmission configuration indicator is simultaneousTCT-UpdateList1-r16 or simultaneousTCT-UpdateList2-r16, and the corresponding channels comprise a physical downlink shared channel, a physical downlink control channel, or a combination thereof.

In some embodiments, the carrier list for concurrently updating the spatial information is simultaneousSpatial-UpdateList1-r16 or simultaneousSpatial-UpdateList2-r16, and the corresponding channels comprise a physical downlink shared channel, a physical downlink control channel, or a combination thereof.

In various embodiments, the transmission configuration indicator, the spatial information, or the combination thereof is applied to all bandwidth parts of the carriers.

In one embodiment, the transmission configuration indicator, the spatial information, or the combination thereof is applied to all bandwidth parts of the carriers in response to a parameter TCI_all_bandwidth_parts being configured as enabled.

In certain embodiments, the transmission configuration indicator bitmap field is configured by radio resource control signaling.

In some embodiments, the downlink control information is a downlink control information format 0_1, 0_2, 1_1, or 1_2.

In various embodiments, the downlink control information is common downlink control information for a plurality of user equipments, and the downlink control information is scrambled by a TCI-update-RNTI.

In one embodiment, the downlink control information comprises a plurality of blocks, each block of the plurality of blocks corresponds to a user equipment of the plurality of user equipments, each block of the plurality of blocks has a corresponding index, and radio resource control signaling configures which block index corresponds to which user equipment.

In certain embodiments, each block of the plurality of blocks comprises a carrier indicator, a bandwidth part indicator, a transmission configuration indicator state, a spatial information indicator, a transmission configuration indicator update indicator, or some combination thereof.

In one embodiment, an apparatus comprises: a transmitter that transmits downlink control information with a transmission configuration indicator, spatial information, or a combination thereof and a transmission configuration indicator bitmap field, wherein each bit in the transmission configuration indicator bitmap field indicates whether the transmission configuration indicator, the spatial information, or the combination thereof applies to a channel or resource group.

In certain embodiments, the channel comprises a physical downlink shared channel, a physical uplink shared channel, or a combination thereof, and the resource group comprises a control resource set group, a physical uplink control channel resource group, or a combination thereof.

In some embodiments, the control resource set group is defined by radio resource control signaling to be a set of control resource sets that share the same transmission configuration indicator state.

In various embodiments, the transmission configuration indicator, the spatial information, or the combination thereof applies to channels in a carrier indicated by a carrier indicator field of the downlink control information and to a bandwidth part indicated by a bandwidth part indicator field of the downlink control information.

In one embodiment, in response to the carrier being part of a carrier list for concurrently updating the transmission configuration indicator, the spatial information, or the combination thereof, the transmission configuration indicator, the spatial information, or the combination thereof is applied to corresponding channels, resource groups, or a combination thereof in all carriers of the carrier list.

In certain embodiments, the carrier list for concurrently updating the transmission configuration indicator is simultaneousTCI-UpdateList1-r16 or simultaneousTCI-UpdateList2-r16, and the corresponding channels comprise a physical downlink shared channel, a physical downlink control channel, or a combination thereof.

In some embodiments, the carrier list for concurrently updating the spatial information is simultaneousSpatial-UpdateList1-r16 or simultaneousSpatial-UpdateList2-r16, and the corresponding channels comprise a physical downlink shared channel, a physical downlink control channel, or a combination thereof.

In various embodiments, the transmission configuration indicator, the spatial information, or the combination thereof is applied to all bandwidth parts of the carriers.

In one embodiment, the transmission configuration indicator, the spatial information, or the combination thereof is applied to all bandwidth parts of the carriers in response to a parameter TCI_all_bandwidth_parts being configured as enabled.

In certain embodiments, the transmission configuration indicator bitmap field is configured by radio resource control signaling.

In some embodiments, the downlink control information is a downlink control information format 0_1, 0_2, 1_1, or 1_2.

In various embodiments, the downlink control information is common downlink control information for a plurality of user equipments, and the downlink control information is scrambled by a TCI-update-RNTI.

In one embodiment, the downlink control information comprises a plurality of blocks, each block of the plurality of blocks corresponds to a user equipment of the plurality of user equipments, each block of the plurality of blocks has a corresponding index, and radio resource control signaling configures which block index corresponds to which user equipment.

In certain embodiments, each block of the plurality of blocks comprises a carrier indicator, a bandwidth part indicator, a transmission configuration indicator state, a spatial information indicator, a transmission configuration indicator update indicator, or some combination thereof.

In one embodiment, a method comprises: receiving downlink control information with a transmission configuration indicator, spatial information, or a combination thereof and a transmission configuration indicator bitmap field, wherein each bit in the transmission configuration indicator bitmap field indicates whether the transmission configuration indicator, the spatial information, or the combination thereof applies to a channel or resource group.

In certain embodiments, the channel comprises a physical downlink shared channel, a physical uplink shared channel, or a combination thereof, and the resource group comprises a control resource set group, a physical uplink control channel resource group, or a combination thereof.

In some embodiments, the control resource set group is defined by radio resource control signaling to be a set of control resource sets that share the same transmission configuration indicator state.

In various embodiments, the transmission configuration indicator, the spatial information, or the combination thereof applies to channels in a carrier indicated by a carrier indicator field of the downlink control information and to a bandwidth part indicated by a bandwidth part indicator field of the downlink control information.

In one embodiment, in response to the carrier being part of a carrier list for concurrently updating the transmission configuration indicator, the spatial information, or the combination thereof, the transmission configuration indicator, the spatial information, or the combination thereof is applied to corresponding channels, resource groups, or a combination thereof in all carriers of the carrier list.

In certain embodiments, the carrier list for concurrently updating the transmission configuration indicator is simultaneousTCI-UpdateList1-r16 or simultaneousTCI-UpdateList2-r16, and the corresponding channels comprise a physical downlink shared channel, a physical downlink control channel, or a combination thereof.

In some embodiments, the carrier list for concurrently updating the spatial information is simultaneousSpatial-UpdateList1-r16 or simultaneousSpatial-UpdateList2-r16, and the corresponding channels comprise a physical downlink shared channel, a physical downlink control channel, or a combination thereof.

In various embodiments, the transmission configuration indicator, the spatial information, or the combination thereof is applied to all bandwidth parts of the carriers.

In one embodiment, the transmission configuration indicator, the spatial information, or the combination thereof is applied to all bandwidth parts of the carriers in response to a parameter TCI_all_bandwidth_parts being configured as enabled.

In certain embodiments, the transmission configuration indicator bitmap field is configured by radio resource control signaling.

In some embodiments, the downlink control information is a downlink control information format 0_1, 0_2, 1_1, or 1_2.

In various embodiments, the downlink control information is common downlink control information for a plurality of user equipments, and the downlink control information is scrambled by a TCI-update-RNTI.

In one embodiment, the downlink control information comprises a plurality of blocks, each block of the plurality of blocks corresponds to a user equipment of the plurality of user equipments, each block of the plurality of blocks has a corresponding index, and radio resource control signaling configures which block index corresponds to which user equipment.

In certain embodiments, each block of the plurality of blocks comprises a carrier indicator, a bandwidth part indicator, a transmission configuration indicator state, a spatial information indicator, a transmission configuration indicator update indicator, or some combination thereof.

In one embodiment, an apparatus comprises: a receiver that receives downlink control information with a transmission configuration indicator, spatial information, or a combination thereof and a transmission configuration indicator bitmap field, wherein each bit in the transmission configuration indicator bitmap field indicates whether the transmission configuration indicator, the spatial information, or the combination thereof applies to a channel or resource group.

In certain embodiments, the channel comprises a physical downlink shared channel, a physical uplink shared channel, or a combination thereof, and the resource group comprises a control resource set group, a physical uplink control channel resource group, or a combination thereof.

In some embodiments, the control resource set group is defined by radio resource control signaling to be a set of control resource sets that share the same transmission configuration indicator state.

In various embodiments, the transmission configuration indicator, the spatial information, or the combination thereof applies to channels in a carrier indicated by a carrier indicator field of the downlink control information and to a bandwidth part indicated by a bandwidth part indicator field of the downlink control information.

In one embodiment, in response to the carrier being part of a carrier list for concurrently updating the transmission configuration indicator, the spatial information, or the combination thereof, the transmission configuration indicator, the spatial information, or the combination thereof is applied to corresponding channels, resource groups, or a combination thereof in all carriers of the carrier list.

In certain embodiments, the carrier list for concurrently updating the transmission configuration indicator is simultaneousTCI-UpdateList1-r16 or simultaneousTCI-UpdateList2-r16, and the corresponding channels comprise a physical downlink shared channel, a physical downlink control channel, or a combination thereof.

In some embodiments, the carrier list for concurrently updating the spatial information is simultaneousSpatial-UpdateList1-r16 or simultaneousSpatial-UpdateList2-r16, and the corresponding channels comprise a physical downlink shared channel, a physical downlink control channel, or a combination thereof.

In various embodiments, the transmission configuration indicator, the spatial information, or the combination thereof is applied to all bandwidth parts of the carriers.

In one embodiment, the transmission configuration indicator, the spatial information, or the combination thereof is applied to all bandwidth parts of the carriers in response to a parameter TCI_all_bandwidth_parts being configured as enabled.

In certain embodiments, the transmission configuration indicator bitmap field is configured by radio resource control signaling.

In some embodiments, the downlink control information is a downlink control information format 0_1, 0_2, 1_1, or 1_2.

In various embodiments, the downlink control information is common downlink control information for a plurality of user equipments, and the downlink control information is scrambled by a TCI-update-RNTI.

In one embodiment, the downlink control information comprises a plurality of blocks, each block of the plurality of blocks corresponds to a user equipment of the plurality of user equipments, each block of the plurality of blocks has a corresponding index, and radio resource control signaling configures which block index corresponds to which user equipment.

In certain embodiments, each block of the plurality of blocks comprises a carrier indicator, a bandwidth part indicator, a transmission configuration indicator state, a spatial information indicator, a transmission configuration indicator update indicator, or some combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method performed by a base station, the method comprising:
transmitting downlink control information (DCI) with a transmission configuration indicator (TCI), spatial information, or a combination thereof and a TCI bitmap field, wherein each bit in the TCI bitmap field indicates whether the TCI, the spatial information, or the combination thereof applies to a channel or resource group.

2. The method of claim 1, wherein the channel comprises a physical downlink shared channel (PDSCH), a physical uplink shared channel (PUSCH), or a combination thereof, and the resource group comprises a control resource set (CORESET) group, a physical uplink control channel (PUCCH) resource group, or a combination thereof.

3. The method of claim 2, wherein the CORESET group is defined by radio resource control (RRC) signaling to be a set of CORESETs that share the same TCI state.

4. The method of claim 1, wherein the TCI, the spatial information, or the combination thereof applies to channels in a carrier indicated by a carrier indicator field of the DCI and to a bandwidth part indicated by a bandwidth part indicator field of the DCI.

5. The method of claim 4, wherein, in response to the carrier being part of a carrier list for concurrently updating the TCI, the spatial information, or the combination thereof, the TCI, the spatial information, or the combination thereof is applied to corresponding channels, resource groups, or a combination thereof in all carriers of the carrier list.

6. The method of claim 5, wherein the carrier list for concurrently updating the TCI is simultaneousTCI-UpdateList1-r16 or simultaneousTCI-UpdateList2-r16, and the corresponding channels comprise a physical downlink shared channel (PDSCH), a physical downlink control channel (PDCCH), or a combination thereof.

7. The method of claim 5, wherein the carrier list for concurrently updating the spatial information is simultaneousSpatial-UpdateList1-r16 or simultaneousSpatial-UpdateList2-r16, and the corresponding channels comprise a physical downlink shared channel (PDSCH), a physical downlink control channel (PDCCH), or a combination thereof.

8. The method of claim 5, wherein the TCI, the spatial information, or the combination thereof is applied to all bandwidth parts of the carriers.

9. The method of claim 5, wherein the TCI, the spatial information, or the combination thereof is applied to all bandwidth parts of the carriers in response to a parameter TCI_all_bandwidth_parts being configured as enabled.

10. The method of claim 1, wherein the TCI bitmap field is configured by radio resource control (RRC) signaling.

11. The method of claim 1, wherein the DCI is a DCI format 0_1, 0_2, 1_1, or 1_2.

12. The method of claim 1, wherein the DCI is common DCI for a plurality of user equipments (UEs), and the DCI is scrambled by a TCI-update-RNTI.

13. The method of claim 12, wherein the DCI comprises a plurality of blocks, each block of the plurality of blocks corresponds to a UE of the plurality of UEs, each block of the plurality of blocks has a corresponding index, and radio resource control (RRC) signaling configures which block index corresponds to which UE.

14. The method of claim 13, wherein each block of the plurality of blocks comprises a carrier indicator, a bandwidth part (BWP) indicator, a TCI state, a spatial information indicator, a TCI update indicator, or a combination thereof.

15. A user equipment (UE), comprising:
at least one memory; and
at least one processor coupled with the at least one memory and configured to cause the UE to:
receive downlink control information (DCI) with a transmission configuration indicator (TCI), spatial information, or a combination thereof and a TCI bitmap field, wherein each bit in the TCI bitmap field indicates whether the TCI, the spatial information, or the combination thereof applies to a channel or resource group.

16. A processor for wireless communication, comprising:
at least one controller coupled with at least one memory and configured to cause the processor to:
receive downlink control information (DCI) with a transmission configuration indicator (TCI), spatial information, or a combination thereof and a TCI bitmap field, wherein each bit in the TCI bitmap field indicates whether the TCI, the spatial information, or the combination thereof applies to a channel or resource group.

17. A base station, comprising:
at least one memory; and
at least one processor coupled with the at least one memory and configured to cause the base station to:
transmit downlink control information (DCI) with a transmission configuration indicator (TCI), spatial information, or a combination thereof and a TCI bitmap field, wherein each bit in the TCI bitmap field indicates whether the TCI, the spatial information, or the combination thereof applies to a channel or resource group.

18. The base station of claim 17, wherein the channel comprises a physical downlink shared channel (PDSCH), a physical uplink shared channel (PUSCH), or a combination thereof, and the resource group comprises a control resource set (CORESET) group, a physical uplink control channel (PUCCH) resource group, or a combination thereof.

19. The base station of claim 18, wherein the CORESET group is defined by radio resource control (RRC) signaling to be a set of CORESETs that share the same TCI state.

20. The base station of claim 17, wherein the TCI, the spatial information, or the combination thereof applies to channels in a carrier indicated by a carrier indicator field of the DCI and to a bandwidth part indicated by a bandwidth part indicator field of the DCI.
